(19) United States
(12) Patent Application Publication
(10) Pub. No.: US 2026/0316317 A1
(43) Pub. Date: Oct. 15, 2026

(54) Device And Method For Processing A Material

(71) Applicant: Rychiger AG, Steffisburg (CH)

(72) Inventors: Daniel Aeschlimann, Thun (CH); René Dellsperger, Steffisburg (CH)

(21) Appl. No.: 19/111,107

(22) PCT Filed: Aug. 11, 2023
(86) PCT No.: PCT/EP2023/072336

§ 371 Date: Mar. 12, 2025

(30) Foreign Application Priority Data
Sep. 13, 2022 (EP) 22195424.1

(51) Int. Cl. B26D 7/26; B21D 37/04; B23Q 1/28; B26D 5/02

(52) U.S. Cl. CPC B26D 7/2628; B21D 37/04; B23Q 1/285; B26D 5/02

(57) ABSTRACT

A device includes two carriers each having a processing tool for a material, a linear guide on which the two carriers are arranged in a linearly displaceable manner, and a push rod movably driven along the linear guide in two opposite directions. The carriers each have a coupling device with which each of the carriers can be selectively coupled to the push rod. A controller controls the coupling devices such that the push rod moves the two carriers together along the linear guide, or only one or a subset of the carriers so that a distance between the carriers can be changed. A method for processing, a strip material with a the device wherein the carriers, after each processing cycle of the strip material, are moved together by the push rod alternately in a first direction and in a second direction opposite to the first direction by a first distance.

### TECHNICAL FIELD

The present invention relates to a device and a method for processing a material, in particular a strip material, wherein a plurality of carriers with processing tools are used, which can be positioned at different distances from one another.

### PRIOR ART

Various devices and methods for processing strip material are known in the prior art, in particular methods in which a distance between individual carriers, on which processing tools are attached, can be changed.

U.S. Pat. No. 4,604,934 (PPG Industries) discloses, for example, a system for positioning a plurality of carriages along a bridge spanning a work surface. The outermost carriage is connected to a drive device and the further carriages can be selectively coupled to an adjacent carriage. Each carriage (apart from the outermost carriage) can be clamped to a rod. In order to position the carriages, they are first pushed together in a starting position and then advanced in the coupled configuration by means of the drive device; the rearmost carriage is then successively released from the carriage train at the corresponding position and clamped to the rod. The carriages have a rectangular base body.

EP 0 997 444 (HEGLA) describes a method and a device for positioning a plurality of processing heads of a multi-head processing machine, which can be displaced at least along two spatial axes. Fully automatic positioning of the processing heads along a bridge spanning a cutting table is thereby made possible. The processing heads are assigned to individual carrier carriages and are first arranged as closely as possible to one another for the positioning. The processing heads are then moved by one of the carrier carriages which can be driven along the bridge longitudinal axis; after the respective desired position has been reached, the respective processing head is arrested with respect to the bridge longitudinal axis, released from the assembly and coupled to the already positioned processing heads. For this purpose, in each case two adjacent carrier carriages are connected via one sliding rod, wherein in each case one of the carrier carriages can be clamped to the sliding rod with the aid of a clamping device. The processing heads are present in the form of carriages to which processing tools can be attached.

### SUMMARY OF THE INVENTION

It is an object of the present invention to provide a device belonging to the technical field mentioned at the outset and which is suitable for processing a material, in particular a strip material, wherein a distance between the carriers or the processing tools arranged thereon can be changed.

The solution of the object is defined by the features of claim 1. According to the present invention, the device comprises at least two carriers each having at least one processing tool for the material, at least one linear guide on which the at least two carriers are arranged in a linearly displaceable manner, and a push rod which is movably driven along the at least one linear guide in two opposite directions. The at least two carriers each have a coupling device with which each of the at least two carriers can be selectively coupled to the push rod. The device comprises a controller by means of which the coupling devices can be controlled such that the push rod moves the at least two carriers together along the at least one linear guide, or only one or a subset of the at least two carriers so that a distance between the at least two carriers can be changed.

As a result of the fact that selective coupling of the at least two carriers to the push rod is possible, a distance between the carriers or the processing tools attached thereto can be easily changed. Furthermore, if all the carriers are coupled to the push rod, all the carriers can be moved simultaneously by the push rod.

The device preferably comprises a frame on which the individual components of the device are arranged or supported. The frame preferably comprises bases or feet with which the frame can be placed on a floor.

The processing tools are preferably punching tools and/or deep-drawing tools. As a result, for example, shaped parts can be cut from the material and subsequently three-dimensionally shaped. Alternatively, however, other processing tools can also be arranged on the at least two carriers, such as, for example, pressing tools. The processing tools can carry out a plurality of processing steps during the processing of the material, for example the already mentioned sequence of the processing steps of cutting and three-dimensionally shaping. The sequence of processing steps required for processing the material results in a processing cycle. In the already mentioned example for the production of a deep-drawn shaped part, therefore, the processing steps of cutting and subsequent three-dimensional shaping together form a processing cycle.

The strip material processed with the processing tools is preferably a metal, paper, cardboard or plastic strip. The thickness of the strip material can be different, but is preferably in the range from 0.1 mm to 10 mm.

The at least two carriers preferably consist of a metal or a metal alloy, in particular of aluminum, steel or stainless steel. Alternatively, the at least two carriers can preferably consist of plastic, in particular a reinforced plastic, such as, for example, a plastic reinforced with glass or carbon fibers. The at least two carriers comprise at least one friction bearing, at least one roller or the like, so that the at least two carriers are movably arranged on the at least one linear guide. The at least one linear guide accordingly preferably comprises a friction bearing, a guide rail or a guide groove.

The device preferably comprises more than two carriers, in particular more than 5 carriers, preferably 10, 11 or 12 carriers. The maximum number of carriers which the device comprises generally depends on the width of the material to be processed and on the size or the diameter of the processing tools, wherein the device can also comprise fewer carriers than the maximum number of carriers depending on the intended processing of the material or depending on the method used. Furthermore, the device may comprise more than one linear guide, the linear guides being arranged parallel and in particular spaced apart from one another.

The at least one linear guide extends in the horizontal direction when the device is used as intended. If more than one linear guide is present, the linear guides are preferably arranged spaced apart from one another. The linear guides are preferably spaced apart from one another in the vertical direction when the device is used as intended. The linear guides can be arranged directly below one another in the vertical direction, i.e. in the same vertically arranged plane. However, the linear guides are preferably arranged offset from one another in the horizontal direction, i.e. they are not located in the same vertical plane when the device is used as intended, but in vertical planes offset horizontally from one another.

The device particularly preferably comprises two parallel linear guides.

The at least one linear guide preferably comprises stops at both ends which limit the movement of the at least two carriers to a defined displacement range.

The push rod is preferably arranged parallel to the at least one linear guide and is movably supported on the at least one linear guide or on the frame of the device by means of at least one bearing, in particular a friction bearing or a rolling bearing. The push rod is moved in the two opposite directions by means of a drive, in particular by means of an electric motor, an electromechanical drive, a pneumatic drive or a hydraulic drive.

The push rod preferably has a round cross section. Alternatively, however, the push rod can also have a different cross section, e.g. square, rectangular, oval or polygonal. The push rod is preferably made of a metal or a metal alloy so that it is as stiff as possible. Alternatively, however, the push rod can also consist of a different material, e.g. a polymer, in particular a carbon fiber-reinforced plastic.

The coupling devices comprise means with which the respective coupling device can be selectively coupled to the push rod. The coupling preferably takes place in a force-fitting and/or form-fitting manner, wherein the coupling devices comprise corresponding means for establishing a force-fitting and/or form-fitting connection to the push rod. Alternatively, however, the coupling can also take place by means of magnetic force, for example by means of an electromagnet.

By coupling to the push rod, a carrier can thus be moved by the latter along the at least one linear guide. By selectively decoupling a carrier from the push rod, the latter can be positioned at a specific position along the at least one linear guide without being moved by further movements of the push rod itself. Such a selective system can be used, for example, to change the distance between the at least two carriers or, depending on the processing of the strip material, to leave one or more carriers which do not have to be used, in particular immovably, at a parking position.

The controller preferably comprises at least one microcontroller or microprocessor. Furthermore, the controller preferably comprises a non-volatile memory and input and output means, for example in the form of a touchscreen. The controller is preferably connected to the coupling devices of the at least two carriers via at least one data connection, for example a data cable connection or a wireless data connection, such that, by means of the controller, each carrier can be selectively coupled to the push rod or decoupled therefrom by the coupling device arranged thereon.

The controller is further preferably connected to the drive of the push rod and to the processing tools. As a result, the movement of the push rod and the function of the processing tools can be controlled by means of the controller.

To change a spacing between the at least two carriers, a first of the carriers can be coupled to the push rod while the at least one further carrier is decoupled from the push rod. By a corresponding movement of the push rod in one of the two directions by a predetermined distance, the spacing between the first carrier and a carrier adjacent thereto can thus be easily and automatically changed. If the device has more than two carriers, a spacing of each carrier from an adjacent carrier can be changed in the manner described. With the change in the spacing of the at least two carriers from one another, the spacing of the processing tools arranged on the carriers is of course also changed.

For example, if the device is used for cutting shaped parts from a strip material, a change in the spacing can be necessary in order to cut shaped parts with a different size and/or shape. By changing the spacing, an overlap of the cut-out shaped parts on the strip material or excessive waste of the strip material remaining after the cutting of the shaped parts can be avoided.

By coupling all carriers to the push rod, the carriers can all be moved together by means of the push rod. As a result, for example, the carriers can be moved periodically by a specific distance, in particular after each processing cycle. The movement preferably alternates between each of the mutually opposite directions. As a result, when cutting shaped parts, for example circular shaped parts, optimum utilization of the material can be achieved when the processing tools or their carriers are each displaced by at least half the diameter of the circular shaped parts after each working cycle.

The coupling devices of the at least two carriers preferably each comprise a rod clamp, in particular a pneumatic, magnetic, electric or spring-loaded rod clamp, which interacts selectively with the push rod.

In this case, the carriers are coupled to the push rod by a clamping force, that is to say by frictional engagement. The rod clamp preferably has an opening through which the push rod is passed, wherein at least one clamping element is arranged in the region of the opening, which clamping element can be brought into an extended state where it presses against the push rod in order to bring the rod clamp into frictional engagement with the push rod. The at least one clamping element is preferably pretensioned by a spring element into a retracted state in which the at least one clamping element does not interact with the push rod, that is to say is not pressed onto the push rod. The at least one clamping element is moved from the retracted state into the extended state in particular by an actuator, preferably by a pneumatic cylinder.

The at least one clamping element consists of or comprises, on a surface directed toward the push rod, a material having a high coefficient of static friction, for example rubber, in order to ensure a coupling to the push rod which is as slip-resistant as possible.

The push rod is preferably connected at one end to a carriage which is linearly movable in two directions along an axis which runs parallel to the at least one linear guide by means of an electric or electromechanical drive.

This allows to provide a simply constructed, reliable and mechanically loadable drive for the push rod. The carriage moves within a defined movement range which is arranged in particular laterally relative to an imaginary extension of the extension axis of the at least one linear guide on the frame of the device, wherein the carriage preferably runs on at least one guide rail or in at least one guide groove by means of rollers.

The drive can be located directly on the carriage. However, the drive is preferably arranged on the frame of the device and is operatively connected to the carriage by means of a drive member, for example a chain. The drive or the carriage preferably comprises means with which the position of the carriage along at least one guide rail or guide groove can be determined. For this purpose, the drive of the carriage can comprise, for example, a stepping motor or servomotor, or a roller of the carriage can comprise a rotary encoder disc with which the angle of rotation of the roller can be measured. Alternatively, sensors can also be present with which the position of the carriage relative to the sensor can be measured, e.g. an ultrasonic sensor.

The push rod is preferably likewise arranged on a carriage at its second end. Alternatively, however, the push rod can also be guided in a sliding or rolling bearing at the second end.

The drive of the carriage is preferably connected to the controller by means of a line and is controlled by the controller. Further, a sensor for the rotary encoder disc or some other sensor, with which the position of the carriage can be measured, isalso preferably connected to the controller.

The carriage is preferably movable by means of a toothed belt which is connected to an output of an electric motor, in particular a servomotor, or by means of a linear motor. As a result, a secure and slip-free connection between the drive and the carriage is possible.

The toothed belt preferably runs over a deflection roller which is arranged at the same time at the end of the movement range of the carriage, i.e. at one end of the at least one guide rail or guide groove. A fastening of the deflection roller to the frame thereby forms a stop for the carriage. The deflection roller is preferably arranged on the frame between the movement range of the carriage and the at least one linear guide. The deflection roller or its fastening preferably forms a stop for the at least two carriers. The electric motor is preferably arranged at the other end of the movement range of the carriage.

The toothed belt is preferably fixedly connected to the carriage, for example by means of a screw connection or clamping connection.

At least one locking element is preferably arranged along the at least one linear guide at a defined position, the locking element interacting with a positioning element of one of the at least two carriers in order to lock the carrier at the defined position.

As a result, at least one of the at least two carriers can be locked in a movement-fixed manner at the defined position. The at least one locking element can be fastened to the at least one linear guide or to the frame of the device. The device preferably comprises a locking element for each of the at least two carriers. The at least one locking element is preferably arranged at a parking position of at least one of the at least two carriers along the at least one linear guide. As a result, this carrier can be locked at the parking position, e.g. in the case that fewer processing tools than are present are required for the processing of the material.

The at least one locking element and the positioning element preferably interact with each other in a form-fitting manner. Alternatively, however, the locking element and the positioning element can also interact with each other by means of a magnetic force, for example by means of an electromagnet.

The at least one locking element preferably comprises a positioning pin which is moveable from a retracted state into an extended state in which extended state the positioning pin engages with the positioning element of at least one carrier.

As a result, a secure and precise but simply constructed locking of the locking element with the positioning element is possible. The positioning element preferably comprises a cylindrical receptacle for the positioning pin. The cylindrical receptacle preferably comprises a conical opening so that the positioning pin is guided into the opening when moving into the extended state even when the carrier or the positioning element arranged thereon is not located quite precisely at the defined position.

The at least one positioning pin is preferably pretensioned in the retracted state by means of a spring element and can be selectively moved into the extended state by means of an actuator, in particular a pneumatic actuator.

This ensures that the operation of the device is not disturbed by a positioning pin which is blocked in the extended state. The correct movement of the positioning pin into the retracted and/or extended state is preferably monitored by a sensor.

The at least two carriers each comprise at least one slide which is displaceably arranged on the at least one linear guide. The at least one slide preferably comprises at least one friction bearing, at least one roller or at least one wheel which runs on the linear guide. The at least two carriers preferably each comprise the same number of slides as the number of linear guides of the device. The at least one friction bearing of the at least one slide preferably slides on a friction bearing or a surface of the at least one linear guide. The linear guide in this case preferably comprises lateral guide elements for the at least one slide or the at least one friction bearing. If the at least one slide comprises at least one roller or at least one wheel, the at least one slide preferably runs in at least one guide groove or on at least one guide rail of the at least one linear guide.

The at least two carriers preferably each comprise at least one processing tool for cutting and/or three-dimensionally shaping a strip material.

The at least two carriers preferably comprise the same processing tools, so that the same working steps per working cycle can be carried out in parallel on the material by means of the processing tools arranged on the at least two carriers.

The at least two carriers preferably each comprise the following:
a) a first arm having a first end and a second end;
b) a first fastening area for an upper processing tool, wherein the first fastening area is arranged in the region of the first end of the first arm;
c) a second arm which is arranged parallel to the first arm and at a first interval therefrom, wherein the second arm has a third end and a fourth end;
d) a second fastening area for a lower processing tool, wherein the second fastening area is arranged in the region of the third end of the second arm, such that the upper processing tool and the lower processing tool can interact in order to process a strip material running between the first arm and the second arm;
e) a connecting arm which is connected to the second end of the first arm and to the fourth end of the second arm;
f) a first slide and a second slide, by means of which the carrier can be movably arranged on two linear guides, wherein the first slide is arranged on the first arm and the second slide is arranged on the second arm.

In this embodiment of the at least two carriers, the device comprises two parallel linear guides which are arranged at a first spacing from one another. The first spacing preferably extends in the vertical direction when the device is used as intended. Furthermore, the two linear guides in this embodiment are arranged offset from one another in the horizontal direction at a second spacing from one another when the device is used as intended.

The device preferably comprises conveying means in order to feed a strip material to the processing tools.

The conveying means can be configured differently depending on the type of strip material to be processed by the device. The conveying means preferably comprises at least one driven roller or drum on which the strip material rests. Roller or drum pairs between which the strip material runs through may also be used. The device may further preferably also comprise a conveyor belt or a roller belt on which the strip material rests. Alternatively, however, the device may also comprise vacuum belts with which the strip material can be conveyed.

The device may preferably comprise a suspension to which a roller of the strip material can be attached, wherein the strip material is unwound from the roller and fed to the processing tools.

If the at least two carriers comprise a first arm, a second arm and a connecting arm according to the description above, the conveying means are configured such that the strip material is fed to the processing tools in the direction of extent of the first and second arms and in the direction towards the connecting arm. In this embodiment, the device preferably comprises at least one cutting element with which the strip material can be cut to length after each processing cycle or after a specific number of processing cycles, so that the strip material does not run into the connecting arms of the at least two carriers.

The conveying means are furthermore configured to convey the strip material by a specific distance after each processing cycle, so that unprocessed strip material is available in the following processing cycle.

If circular shaped parts are punched out of the strip material by means of the device, the strip material is moved by the conveying means by at least half the diameter of the circular shaped parts after a processing cycle.

The present invention further relates to a method for processing, in particular for cutting and/or three-dimensionally shaping, a strip material with a device according to the description above. The at least two carriers, after each processing cycle of the strip material by the processing tools, are moved together by means of the push rod alternately in a first direction and in a second direction opposite to the first direction by a first distance.

As already described, a processing cycle comprises all processing steps which are required in order, for example, to produce a shaped part from the strip material, that is to say, for example, a step to cut out the shaped part and a possible downstream deep-drawing step.

Preferably, after each processing cycle, all the carriers of the device are moved together, wherein for this purpose all the carriers are coupled to the push rod by means of their respective coupling device.

The movement after each processing cycle permits particularly advantageous utilization of the strip material since, during each processing cycle, the processing tools are offset from their position assumed in the preceding processing cycle.

Preferably, the strip material is processed during each processing cycle by the processing tools of all the carriers. Alternatively, however, in every second processing cycle, the at least one processing tool of at least one of the at least two carriers is not used to process the strip material. As a result, strip material which is not wide enough to be processed by the processing tools of all the carriers when the carriers are offset by the first distance may still be processed by the method.

Preferably, circular shaped parts are punched out of the strip material and the at least two carriers are moved after each punching operation, wherein the first distance corresponds to at least half the diameter of the circular shaped parts. The strip material is preferably moved by conveying means after each processing cycle by a second distance which corresponds to at least half the diameter of the circular shaped parts.

Particularly good utilization of the strip material is achieved by the alternating movement of the carriers and the movement of the strip material after each processing cycle. As a result, only a small amount of excess strip material has to be disposed of as waste.

Preferably, before the processing of the strip material, the distance between the at least two carriers is altered by the following steps:
a) releasing all the coupling devices and moving the push rod in the first direction from a base position into an end position;
b) coupling the push rod to a first carrier which is located furthest from a stop element of the at least one linear guide;
c) moving the push rod and the first carrier coupled to the push rod in the second direction until a carrier which is located closest to the stop element strikes against the stop element;
d) decoupling the first carrier from the push rod;
e) moving the push rod in the second direction to the base position;
f) coupling the first carrier to the push rod and moving the push rod and the first carrier coupled thereto in the first direction by a predefined distance;
g) sequentially coupling a carrier which is adjacent to the carrier moved by the preceding movement of the push rod to the push rod and moving the same by the predefined distance in the first direction.

This allows to alter the spacing between the at least two carriers which is as simple as possible but precise. By changing the spacing, the device can be used for processing a strip material with different processing tools. For this purpose, the processing tools attached to the at least two carriers or component parts of the processing tools can be exchanged. For example, if punching tools are attached to the at least two carriers, when the punching dies are exchanged, the spacing between the carriers can be adjusted according to the size of the exchanged punching dies.

Preferably, when changing the spacing between the at least two carriers, the spacing between all carriers is adjusted equally. Alternatively, however, the spacing between in each of two adjacent carriers can be adjusted differently.

Preferably, step g) is carried out until the carrier which is adjacent to the carrier located closest to the stop element has been moved. This means that the carrier located closest to the stop element is not moved when changing the spacing of the at least two carriers. As a result, the change in the spacing can be carried out more quickly than if all the carriers are moved for this purpose.

Preferably, between steps d) and e), all the carriers are locked in their position in each case by means of engagement of a locking element with positioning elements of the carriers, wherein, before the movement of the push rod in step f) or in step g), the positioning pin of the carrier to be moved is retracted in order to unlock said carrier.

This ensures that carriers which are not intended to be moved remain securely in their position. As a result, the precision when adjusting the spacing can be improved.

Further advantageous embodiments and combinations of features of the invention may be derived from the following detailed description and the entirety of the patent claims.

### BRIEF DESCRIPTION OF THE DRAWINGS

The drawings used to explain the exemplary embodiments show:

FIG. 1 a schematic illustration of a first embodiment of a device according to the invention;

FIGS. 2-6 different steps when adjusting the spacing between the carriers of a device according to the invention;

FIG. 7 a strip material which has been partially processed by a method according to the invention;

FIG. 8 a strip material which has been partially processed by a method which is an alternative to the method according to FIG. 7;

FIG. 9 a second embodiment of a device according to the invention;

FIG. 10 an embodiment of a carrier;

FIG. 11 the interaction of an embodiment of a positioning element with a locking element.

In principle, identical parts are provided with identical reference numerals in the figures.

### WAYS OF CARRYING OUT THE INVENTION

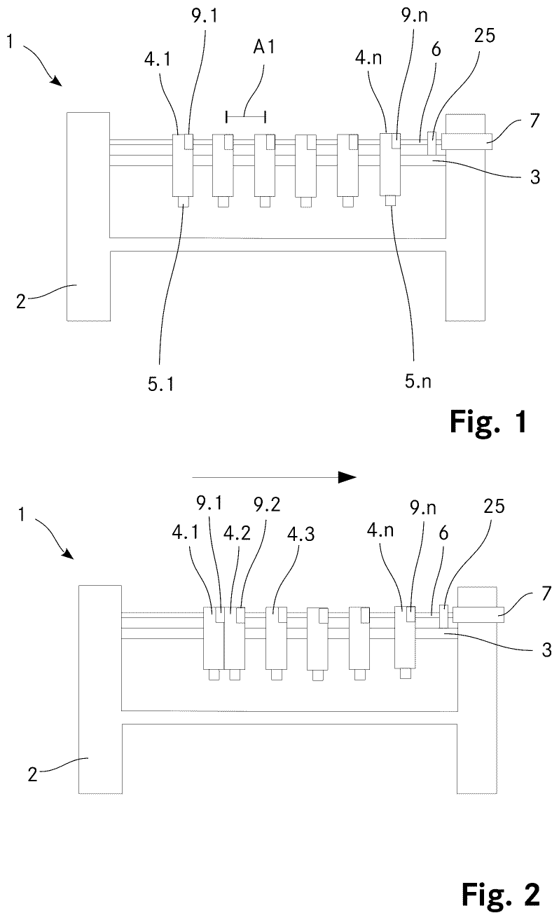

FIG. 1 shows a schematic illustration of a first embodiment of a device 1 according to the invention. The device 1 comprises a frame 2 with which the device 1 can be placed on a floor and on which the components of the device 1 are arranged. The device 1 further comprises a linear guide 3 on which a plurality of carriers 4.1-4.n are movably arranged. A processing tool 5.1-5.n is fastened to each of the carriers 4.1-4.n. A material, in particular a strip material, can be processed by means of the processing tools 5.1-5.n. The device 1 further comprises a push rod 6 which is arranged parallel to the linear guide 3. The push rod 6 is movably mounted in two directions and is set in motion by a drive 7. Each carrier 4.1-4.n comprises a coupling device 9.1-9.n. Each carrier 4.1-4.n can be selectively coupled to the push rod 6 by means of the coupling device 9.1-9.n. In the coupled state, the respective carrier 4.1-4.n is moved by the push rod 6 along the linear guide 3. The device 1 further comprises a stop element 25 which limits the movement of the carriers 4.1-4.n. In FIG. 1, the carriers 4.1-4.n are arranged at a first spacing A1 from one another.

FIG. 2 shows a first step of the method according to the invention for altering the spacing of the carriers 4.1-4.n which are arranged at a first spacing A1 from one another in FIG. 2. In this step, all the coupling devices 9.1-9.n are first released and the push rod 6 is moved in a first direction, which is opposite to the arrow shown in FIG. 2, into an end position.

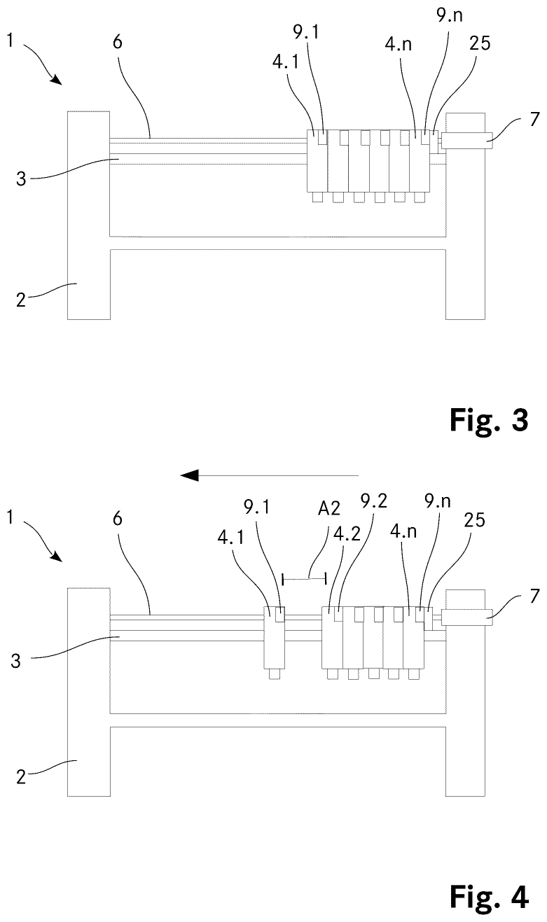

A first carrier 4.1 which is furthest away from the stop element 25 is then coupled to the push rod 6 by means of its coupling device 9.1. The push rod is moved by the drive 7 in a second direction which is opposite to the first direction and is symbolized by the arrow in FIG. 2. As a result of this movement, the first carrier 4.1 moves onto a second carrier 4.2 adjacent to it and then pulls it along in the second direction. The second carrier 4.2 then moves onto a further carrier 4.3 adjacent to it and so on. Finally, the carrier train moves onto the carrier 9.n located closest to the stop element 25 and pulls it along until it moves onto the stop element 25, as is shown in FIG. 3.

The coupling device 9.1 of the first carrier 4.1 is decoupled from the push rod 3 and the push rod 3 is moved in the second direction into a base position. The first carrier 4.1 is then coupled to the push rod 3 again by means of its coupling device 9.1 and the push rod 3 with the first carrier 4.1 coupled thereto is moved by the drive 7 in the first direction by a predefined distance A2, as is shown in FIG. 4. The predefined distance A2 in this case corresponds to the new spacing of the carriers 4.1-4.n. The carrier 4.2 adjacent to the first carrier 4.1 is then coupled to the push rod 6 by means of its coupling device 9.2 and the push rod with the first carrier 4.1 and second carrier 4.2 coupled thereto is moved by the predefined distance A2 in the first direction.

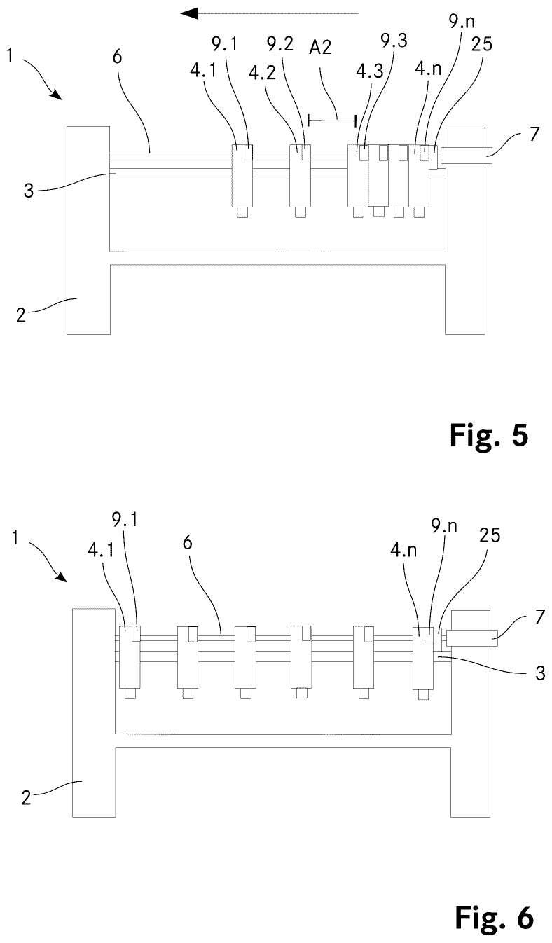

The remaining carriers 4.3-4.n are sequentially coupled to the push rod in each case after the movement of the push rod by the predefined distance A2 via the corresponding coupling device 9.3-9.n and the push rod is then moved in turn by the second distance A2 in the first direction, as is shown in FIG. 5. This sequential coupling and movement is repeated until all the carriers 4.1-4.n are spaced apart from one another by the predefined distance A2. However, the carrier 4.n located closest to the stop element 25 does not have to be moved but, as shown in FIG. 6, can remain in its position. By coupling all the coupling devices 9.1-9.n, all the carriers 4.1-4.n can then be moved simultaneously by means of the push rod 6.

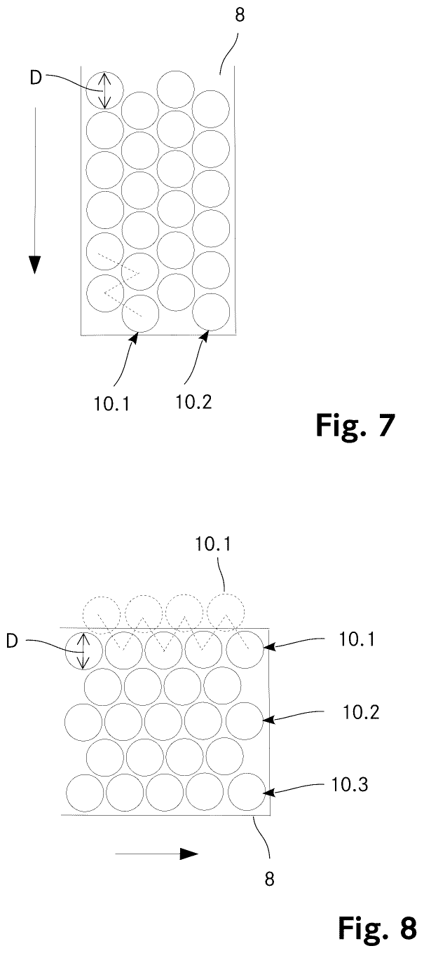

FIG. 7 shows a strip material 8 which has been partially processed by a device 1 according to the invention. In this embodiment, the processing tools 5.1-5.n of the carriers 4.1-4.n are punching tools with which circular shaped parts are punched out of the strip material. The processing tools 5.1-5.n arranged next to one another in each cut rows 10.1-10.2 of circular shaped parts out of the strip material 8. The circular shaped parts all have the same diameter D. During the processing of the strip material 8, the carriers 4.1-4.n are all arranged at the same spacing from one another. After each processing cycle, all the carriers 4.1-4.n are moved alternately in the first and the second direction by a defined first distance which is somewhat greater than half the diameter D of the circular shaped parts. In addition, the strip material 8 is moved to the left in the viewing direction by a second distance which is likewise somewhat greater than half the diameter D of the circular shaped parts.

By the alternating offsetting of the carriers 4.1-4.n in the first and second direction by the first distance after each processing cycle and the simultaneous movement of the strip material 8, the circular shaped parts can be punched out of the strip material 8 offset from one another in a material-saving manner. The offset can be seen particularly well by means of the dashed line which traces the displacement of the center of the lowermost circular shaped part.

The first distance and the second distance are each more than half the diameter D of the circular shaped parts in order to ensure that there is no overlap of the shaped parts.

FIG. 8 illustrates a strip material 8 which has been partially processed by a method which is an alternative to the method according to FIG. 7. In this method, in every second processing cycle, the at least one processing tool 5.1 of one of the at least two carriers 4.1 is not used. As a result, in every second working cycle one less circular shaped part is produced in a row 10.1. This makes it possible to use the method according to the invention with strip material 8 which does not have a sufficiently large width in order to be able to cut out the same number of circular shaped parts for each of the rows 10.1-10.3.

It is apparent to a person skilled in the art that the number of carriers 4.1-4.n for the disclosed method may vary depending on the width of the strip material 8 and on the dimension of the at least one processing tool 5.1-5.n. In the method, the processing tools 5 of more than only one carrier 4.1-4.n may also not be used during one processing cycle. It should also be noted that, depending on the width of the strip material 8, one or more carriers 4.1-4.n can remain in a parking position such as not to be moved by the push rod 6. Other processing steps of the strip material 8 can also be carried out by the disclosed method, for example three-dimensional shaping or embossing.

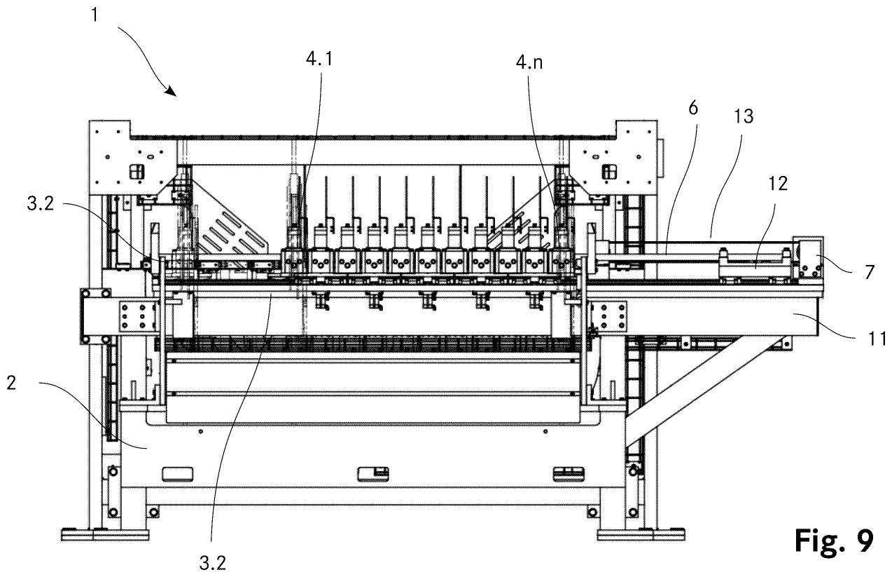

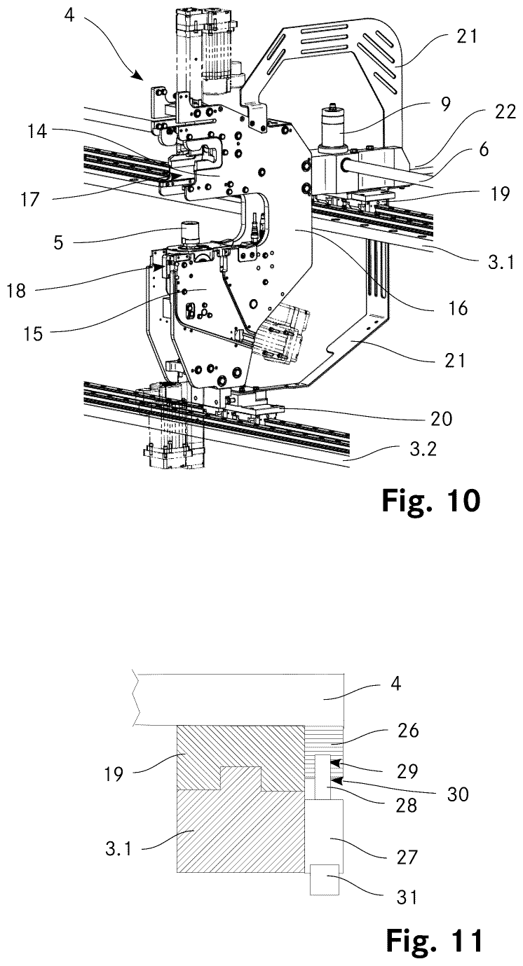

FIG. 9 shows a second embodiment of a device 1 according to the invention. The device 1 comprises a frame 2 with which the device 1 stands on the floor and on which the individual components of the device 1 are attached. The device 1 further comprises two linear guides 3.1, 3.2 arranged parallel to one another and at a first spacing from one another. The carriers 4.1-4.n are movably arranged on the two parallel linear guides 3.1, 3.2 by means of two slides (see FIG. 10). The carriers 4.1-4.n can be moved along the linear guides 3.1, 3.2 by means of a push rod 6 movably arranged on the frame 2 of the device 1 and being parallel to the linear guides 3.1, 3.2. In this case, each of the individual carriers 4.1-4.n can be selectively coupled to the push rod 6 via a coupling device. Thus, an individual carrier, a plurality of carriers or all carriers 4.1-4.n can be moved by coupling to the push rod 6. The push rod 6 is fastened at one end to a carriage 12 which is arranged in a linearly movable manner on a boom 11 of the frame 2. The carriage 12 in this case is movable parallel to the linear guides 3.1, 3.2. A drive 7 which is preferably configured as an electric motor is connected to the carriage 12 by means of a toothed belt 13, so that the carriage 12 can be moved to and fro by means of the drive 7. Depending on the application, the device 1 may comprise a different number of carriers 4.1-4.n. The device 1 is preferably used to cut out and/or three-dimensionally shape shaped parts from a strip material. Accordingly, punching and/or deep-drawing tools are attached to the carriers 4.1-4.n.

FIG. 10 shows an embodiment of a carrier 4. The carrier 4 comprises a first arm 14 with a first and a second end, wherein a first fastening area 17 for fastening an upper processing tool is arranged in the region of the first end. The carrier 4 further comprises a second arm 15 with a third and a fourth end, wherein a second fastening area 18 for a lower processing tool is arranged in the region of the third end. The second end of the first arm 14 and the fourth end of the second arm 15 are connected to each other via a connecting arm 16. The first arm 14 and the second arm 15 run parallel to one another and are arranged at a first spacing from one another. The carrier 4 comprises a first slide 19 which is arranged on the first arm 14, and a second slide 20 which is arranged on the second arm 15. By means of the slides 14, 15, the carrier 4 can be movably arranged on two parallel linear guides, for example on the two linear guides 3.1, 3.2 of the device 1 according to FIG. 9. Processing tools 5 for cutting and/or three-dimensionally shaping a strip material are preferably attached to the carrier 4 at the two fastening areas 17, 18. The carrier 4 further comprises a cable guide 21 with which lines for control signals, current, compressed air or liquids can be guided from a fastening 22 for a drag chain from above or below to the first arm 14 or the second arm 15.

FIG. 11 shows the interaction of an embodiment of a positioning element 26 with a locking element 27. The positioning element 26 is arranged on a carrier 4, while the locking element 27 is attached to a linear guide, in the illustrated embodiment to the first linear guide 3.1. Alternatively, however, the locking element 27 can also be attached to another component of the device 1, in particular to the frame 2. The locking element 27 comprises a positioning pin 28 which can be brought from a retracted state (not shown) into the illustrated extended state, in particular via an actuator (not shown). In the illustrated embodiment, the positioning pin 28 engages in a bore 29 of the positioning element 26. The bore 29 is cylindrical and comprises a conical opening 30 in order to allow automatic centering of the positioning pin 28 within the bore 29. The positioning pin 28 is linearly moved by means of an actuator 30, in particular a pneumatic actuator, and is pretensioned into the extended state by means of a spring element (not shown) within the locking element 27.

1. A device for processing a strip material, the device comprising at least two carriers each including at least one processing tool for the strip material, the device further comprising at least one linear guide on which the at least two carriers are arranged in a linearly displaceable manner, and a push rod configured to be movably driven along the at least one linear guide in two opposite directions, wherein the at least two carriers each include a coupling device by which each of the at least two carriers can be selectively coupled to the push rod, wherein the device further includes a controller, the controller being configured to individually control the coupling devices of the at least two carriers, such that either the coupling devices of all of the at least two carriers are coupled to the push rod in order to collectively move the at least two carriers along the at least one linear guide by the push rod, or such that the coupling device of only one or of a subset of the at least two carriers is coupled to the push rod, so that a distance between the at least two carriers can be altered.

2. The device according to claim 1, wherein the coupling device of each of the at least two carriers comprises a rod clamp interacting with the push rod.

3. The device according to claim 1, wherein the push rod is connected at one end to a carriage, the carriage being linearly moved in two directions along an axis arranged parallel to the at least one linear guide by a pneumatic, an electric or an electromechanical drive.

4. The device according to claim 3, wherein the carriage is configured to be moved by a toothed belt connected to an output of an electric motor, or by a linear motor.

5. The device according to claim 1, wherein at least one locking element is arranged along the at least one linear guide at a defined position, wherein the at least two carriers each comprise a positioning element, and wherein the at least one locking element interacts with the positioning element of one of the at least two carriers in order to lock the carrier at the defined position.

6. The device according to claim 5, wherein the at least one locking element comprises a positioning pin moveable from a retracted state into an extended state, wherein in the extended state the positioning pin engages with the positioning element of one of the at least two carriers.

7. The device according to claim 6, wherein the at least one positioning pin is pre-tensioned in the retracted state by a spring element and is selectively moved into the extended state by an actuator.

8. The device according to claim 1, wherein the at least two carriers each comprise at least one slide displaceably arranged on the at least one linear guide.

9. The device according to claim 1, wherein the at least two carriers each comprise at least one processing tool for cutting and/or three-dimensionally shaping a strip material.

10. The device according to claim 1, wherein the at least two carriers each comprise the following:
a) a first arm having a first end and a second end;
b) a first fastening area to which an upper processing tool is affixed, wherein the first fastening area is arranged in the region of the first end of the first arm;
c) a second arm arranged parallel to the first arm and at a first interval therefrom, wherein the second arm has a third end and a fourth end;
d) a second fastening area to which a lower processing tool is affixed, wherein the second fastening area is arranged in the region of the third end of the second arm, such that the upper processing tool and the lower processing tool can interact in order to process a strip material running between the first arm and the second arm;
e) a connecting arm connected to the second end of the first arm and to the fourth end of the second arm;
f) a first slide and a second slide, by which the carrier can be movably arranged on two linear guides, wherein the first slide is arranged on the first arm and the second slide is arranged on the second arm.

11. The device according to claim 1, wherein the device comprises conveying means in order to feed the strip material to the processing tools.

12. A method for processing a strip material using a device according to claim 1, wherein the at least two carriers, after each processing cycle of the strip material by the processing tools, are moved together by the push rod alternately in a first direction and in a second direction opposite to the first direction by a first distance.

13. The method according to claim 12, wherein circular shaped parts are punched out of the strip material and the at least two carriers are moved after each processing cycle by the first distance, the first distance being half the diameter of the circular shaped parts, and wherein the strip material is moved after each processing cycle by a second distance, the second distance being at least half the diameter of the circular shaped parts.

14. The method according to claim 12, wherein, before the processing of the strip material, a distance between the at least two carriers is altered by the following steps:
a) releasing the coupling devices of all of the at least two carriers and moving the push rod in the first direction from a base position into an end position;
a) coupling a first carrier of the at least two carriers to the push rod, the first carrier being a carrier of the at least two carriers which is located furthest from a stop element arranged on the at least one linear guide;
b) moving the push rod and the first carrier coupled to the push rod in the second direction until a second of the at least two carriers strikes against the stop element, the second carrier being a carrier of the at least two carriers which is located closest to the stop element;
c) decoupling the first carrier from the push rod;
d) moving the push rod in the second direction to the base position;
e) coupling the first carrier to the push rod and moving the push rod and the first carrier coupled thereto in the first direction by a predefined distance;
f) sequentially coupling a further carrier of the at least two carriers to the push rod and moving the same by the predefined distance in the first direction, the further carrier being a carrier of the at least two carriers, which is adjacent to the carrier moved by the preceding movement of the push rod.

15. The method according to claim 14, wherein step g) is carried out until a carrier of the at least two carriers which is adjacent to the carrier located closest to the stop element has been moved.

16. The method according to claim 14, wherein, between steps d) and e), each carrier is locked in its respective position by engaging a locking element arranged on the at least one linear guide with a positioning elements of the respective carrier, and wherein, before the movement of the push rod in step f) or in step g), the positioning pin of the carrier to be moved is retracted in order to unlock said-carrier.
